(19) United States
(12) Patent Application Publication
(10) Pub. No.: US 2018/0015744 A1
(43) Pub. Date: Jan. 18, 2018

(54) CONVEYANCE DETECTION APPARATUS, CONVEYING APPARATUS, AND RECORDING APPARATUS

(71) Applicant: CANON COMPONENTS, INC., Kodama-gun (JP)

(72) Inventors: Kenichi MATSUMOTO, Saitama (JP); Masashi ISHIMARU, Saitama (JP); Yoshihisa NEGISHI, Saitama (JP); Yoshihiro HATTORI, Saitama (JP)

(21) Appl. No.: 15/646,757

(22) Filed: Jul. 11, 2017

(30) Foreign Application Priority Data
Jul. 14, 2016 (JP) 2016-139627

(51) Int. Cl. B41J 13/00; B65H 5/06; B65H 7/14

(52) U.S. Cl. CPC B41J 13/0009; B65H 7/14; B65H 5/062; B65H 2553/42; B65H 2801/15; B65H 2511/413

(57) ABSTRACT

Provided is a control unit of a conveying apparatus, the conveying apparatus including: a conveying unit that conveys recording paper along a conveyance path; and an imaging unit that images the recording paper, wherein the control unit detects conveyance information of the recording paper based on image information of a plurality of different regions in image information of the recording paper P imaged by the imaging unit.

### CROSS-REFERENCE TO RELATED APPLICATIONS

This application is based upon and claims the benefit of priority of the prior Japanese Patent Application No. 2016-139627, filed on Jul. 14, 2016, the entire contents of which are incorporated herein by reference.

### BACKGROUND OF THE INVENTION

### Field of the Invention

The present invention relates to a conveyance detection apparatus, a conveying apparatus, and a recording apparatus.

### Description of the Related Art

There is a known recording apparatus that conveys a recording medium while controlling an amount of conveyance and that records an image on the recording medium. A control apparatus disclosed in Patent Document 1 includes: an imaging apparatus arranged on a conveyance route of recording paper; and a conveyance amount calculation unit that calculates an amount of conveyance of the recording paper based on an image obtained by the imaging apparatus. The conveyance amount calculation unit calculates an actual amount of conveyance of the recording paper from a moving distance of an image pattern on a photographed image.

However, when the recording paper is conveyed in a direction obliquely inclined (hereinafter, called inclined) from an ordinary conveyance direction, and the image pattern is out of an image obtained by the imaging apparatus, the control apparatus of Patent Document 1 has a problem that the moving distance of the image pattern cannot be accurately detected.

### Patent Document 1

### Japanese Laid-Open Patent Publication No. 2007-217176

### SUMMARY OF THE INVENTION

The present invention has been made in view of the problem, and an object of the present invention is to enable detecting highly accurate conveyance information even when a conveyed object is inclined and conveyed.

The present invention provides a conveyance detection apparatus of a conveying apparatus, the conveying apparatus including: a conveying unit that conveys a conveyed object along a conveyance path; and an imaging unit that images the conveyed object, the conveyance detection apparatus including a conveyance detection unit that detects conveyance information of the conveyed object based on image information of a plurality of different regions in image information of the conveyed object imaged by the imaging unit.

The present invention provides a conveying apparatus including: a conveying unit that conveys a conveyed object along a conveyance path; an imaging unit that images the conveyed object; and a conveyance detection unit that detects conveyance information of the conveyed object based on image information of a plurality of different regions in image information of the conveyed object imaged by the imaging unit.

The present invention provides a recording apparatus including: a conveying unit that conveys a conveyed object along a conveyance path; an imaging unit that images the conveyed object; a conveyance detection unit that detects conveyance information of the conveyed object based on image information of a plurality of different regions in image information of the conveyed object imaged by the imaging unit; and a recording unit that records an image based on the conveyance information detected by the conveyance detection unit.

### BRIEF DESCRIPTION OF THE DRAWINGS

FIG. 1 is a view illustrating a schematic configuration of a recording apparatus 100;

FIG. 2 is a block diagram illustrating an internal configuration of the recording apparatus 100;

FIG. 3 is a flow chart illustrating a process by a control unit 50;

FIG. 4 is a flow chart illustrating a process by the control unit 50;

FIG. 5 is a view illustrating an example of first image data 500;

FIG. 6 is a view illustrating an example of second image data 600;

FIG. 7 is a view illustrating an example of second image data 700; and

FIG. 8 is a view illustrating an example of first image data 800.

### DETAILED DESCRIPTION OF THE PREFERRED EMBODIMENTS

An embodiment of the present invention will now be described in detail with reference to the drawings.

The present embodiment provides a conveyance detection apparatus and a conveying apparatus or a recording apparatus including the conveyance detection apparatus. The conveyance detection apparatus detects conveyance information of a conveyed object. The conveying apparatus conveys the conveyed object based on the conveyance information of the conveyed object detected by the conveyance detection apparatus. The recording apparatus forms an image on the conveyed object, specifically, recording paper, detected by the conveyance detection apparatus based on the conveyance information of the recording paper and records the image.

In the following drawings, a conveyance direction of the conveyed object will be expressed as an X direction, a direction orthogonal to the X direction and parallel to a conveyed surface will be expressed as a Y direction, and a direction orthogonal to the conveyed surface will be expressed as a Z direction, as necessary. The side of a paper feeding opening 14 described later in the conveyance direction will be called an upstream, and the side of a paper discharge opening 15 described later will be called a downstream.

### First Embodiment

A recording apparatus 100 according to the present embodiment is applied to an inkjet type printer in the following description.

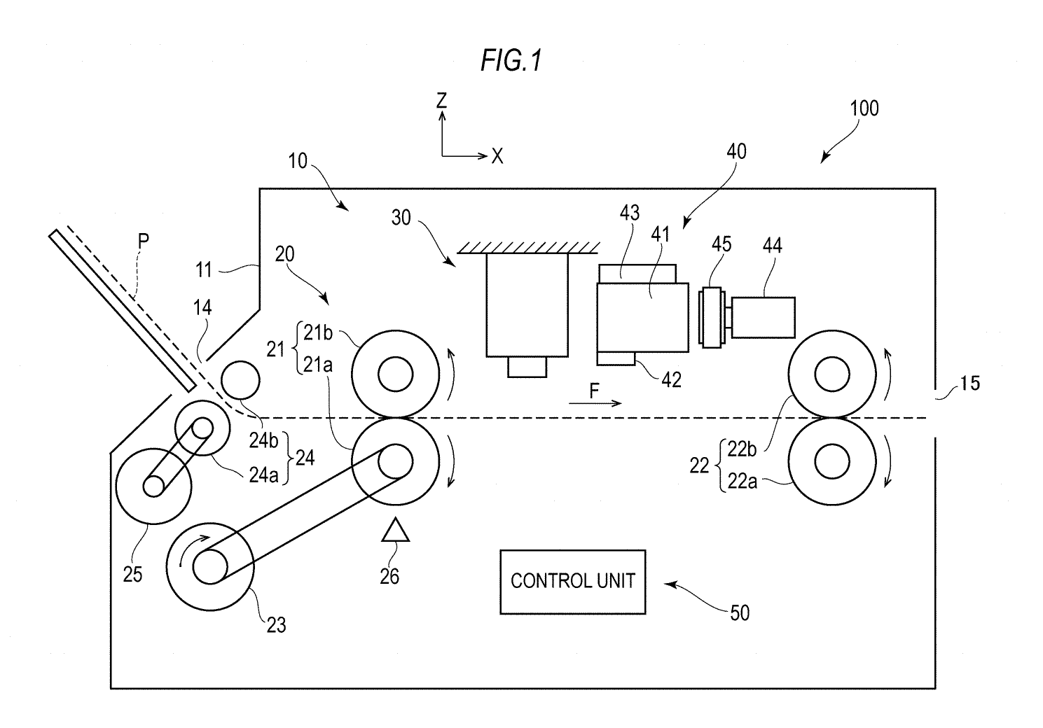

FIG. 1 is a view illustrating a schematic configuration of the recording apparatus 100.

The recording apparatus 100 includes a conveying apparatus 10, a recording unit 40, and a control unit 50 that controls operation of the conveying apparatus 10 and the recording unit 40.

The conveying apparatus 10 conveys a recording medium (hereinafter, called recording paper P) as a fed conveyed object along a conveyance path and discharges the recording medium after the recording medium passes through the recording unit 40. The conveying apparatus 10 includes a housing 11, a conveying unit 20, and an imaging unit 30.

The housing 11 houses and supports constituent members of the recording apparatus 100. The housing 11 includes the paper feeding opening 14 for feeding the recording paper P and the paper discharge opening 15 for discharging the recording paper P.

The conveying unit 20 conveys the recording paper P. The conveying unit 20 includes a first conveyor roller unit 21 and a second conveyor roller unit 22 as rotating bodies, a conveyor motor 23, a paper feeding roller unit 24, a paper feeding motor 25, and an encoder 26.

The first conveyor roller unit 21 includes a pair of rollers 21a and 21b and conveys the recording paper P placed between the rollers 21a and 21b. Similarly, the second conveyor roller unit 22 includes a pair of rollers 22a and 22b and conveys the recording paper P placed between the rollers 22a and 22b. The first conveyor roller unit 21 and the second conveyor roller unit 22 are rotatably supported by the housing 11 at positions separated in the conveyance direction. Therefore, a conveyance path of the recording paper P is formed between the pair of rollers 21a and 21b and between the pair of rollers 22a and 22b (the recording paper P and the conveyance path overlap in FIG. 1). The conveyor motor 23 rotates the first conveyor roller unit 21 and the second conveyor roller unit 22. Therefore, the drive of the conveyor motor 23 conveys the recording paper P placed between the pair of rollers 21a and 21b and the pair of rollers 22a and 22b in the conveyance direction (arrow F illustrated in FIG. 1). The paper feeding roller unit 24 includes a pair of rollers 24a and 24b and places the recording paper P between the rollers 24a and 24b. The paper feeding roller unit 24 separates each of a plurality of pieces of recording paper P loaded on a tray and feeds the recording paper P from the paper feeding opening 14. The paper feeding motor 25 rotates the paper feeding roller unit 24. Therefore, the paper feeding motor 25 rotates to feed the recording paper P placed between the pair of rollers 24a and 24b from the paper feeding opening 14. The encoder 26 detects a rotation state by reading a slit along a circumference of a code wheel not illustrated of the first conveyor roller unit 21 and transmits the detected information to the control unit 50.

The conveying unit 20 may be configured to bring the recording paper P into close contact with a conveyor belt to convey the recording paper P instead of conveying the recording paper P by the pairs of rollers.

The imaging unit 30 two-dimensionally images the surface of the recording paper P being conveyed by the conveying unit 20. More specifically, the imaging unit 30 is supported by the housing 11 such that a direction orthogonal to the surface of the recording paper P is an imaging direction. The imaging unit 30 can include a lens and an image sensor including an image pickup element. The imaging unit 30 is arranged on the upstream of the recording unit 40 in the conveyance direction, and the imaging unit 30 images the surface of the recording paper P before the image is recorded by the recording unit 40. The imaging unit 30 transmits the taken image information to the control unit 50.

The imaging range of the imaging unit 30 can include, for example, 1024 pixels×1024 pixels. Assuming that a pitch of one pixel is, for example, 10 μm here, the imaging range is 10.24 mm×10.24 mm. The imaging range can be set to a size according to an amount of conveyance.

The recording unit 40 records an image or the like on the surface of the conveyed recording paper P. The recording unit 40 is arranged on the downstream of the imaging unit 30 in the conveyance direction and is configured to record the image on the recording paper P after the image is taken by the imaging unit 30. The recording unit 40 includes a carriage 41, a recording head 42, an ink tank 43, and a carriage moving motor 44. The carriage 41 is driven by the carriage moving motor 44 to move back and forth in the direction orthogonal to the conveyance direction of the recording paper P and parallel to the surface of the recording paper P, that is, in the Y direction. The recording head 42 discharges ink from a nozzle toward the surface of the recording paper P in conjunction with the backward and forward movement of the carriage 41. The ink tank 43 supplies stored ink to the recording head 42. The carriage moving motor 44 moves the carriage 41 back and forth through a belt 45.

The recording unit 40 is not limited to the inkjet type, and an electrophotographic type, a thermal transfer type, a dot impact type or the like may also be adopted.

The control unit 50 controls the conveying apparatus 10 and the recording unit 40. Specifically, the control unit 50 alternately repeats instructing the conveying apparatus 10 to convey the recording paper P with an amount of conveyance for one step and instructing the recording unit 40 to discharge the ink from the nozzle of the recording head 42 to record an image for one step. Therefore, a process by the conveying apparatus 10 conveying the recording paper P for one step and a process by the recording unit 40 recording an image for one step are repeated in the recording apparatus 100 to record a desired image on the entire surface of the recording paper P.

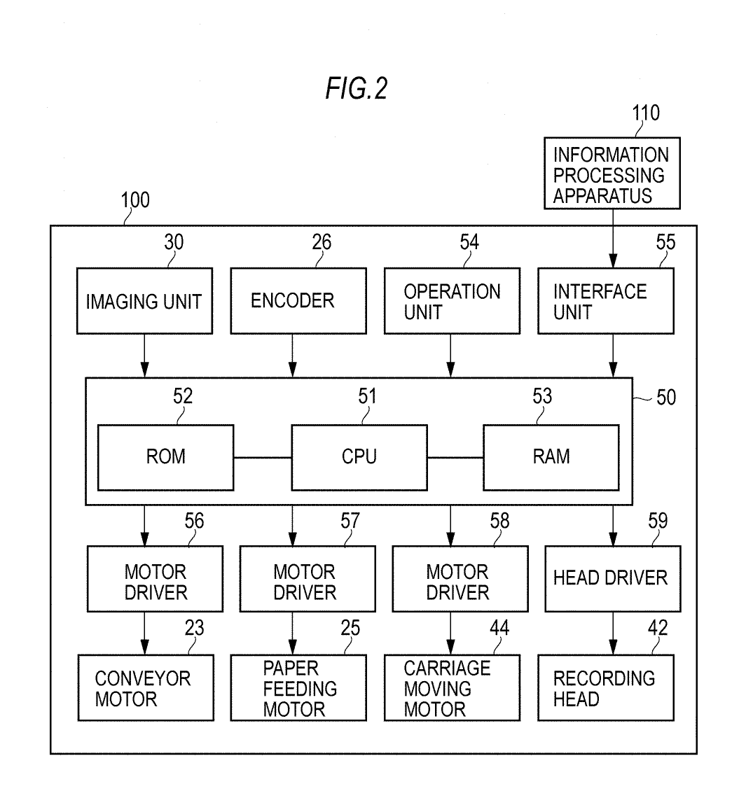

FIG. 2 is a block diagram illustrating an internal configuration of the recording apparatus 100 with a focus on the control unit 50.

The control unit 50 includes a CPU 51, a ROM 52, and a RAM 53 and functions as a so-called computer.

The CPU 51 expands a program stored in the ROM 52 to the RAM 53 and executes the program to control the entire recording apparatus 100. The program and data necessary for a process by the CPU 51 are stored in the ROM 52. The RAM 53 is a memory that temporarily stores information when the CPU 51 executes the process.

The control unit 50 is connected to the imaging unit 30, the encoder 26, an operation unit 54, and an information processing apparatus 110 and is configured to receive information from them. A user operates the operation unit 54 to issue an instruction to the control unit 50. Examples of the operation unit 54 include a switch, a button, and a touch panel. Examples of the information processing apparatus 110 include a PC, a smartphone, and a tablet terminal, and the information processing apparatus 110 is connected in a wireless or wired manner through an interface unit 55.

The control unit 50 is connected to the conveyor motor 23, the paper feeding motor 25, the carriage moving motor 44, and the recording head 42 through motor drivers 56, 57, and 58 and a head driver 59, respectively, and is configured to transmit information to them.

In the recording apparatus 100 configured as described above, the imaging unit 30 images, at different timings, the recording paper P being conveyed and transmits the taken image information to the control unit 50. Based on two pieces of image information taken at different timings, the control unit 50 uses pattern matching to detect conveyance information of the recording paper P, for example, a distance conveyed in the X direction and a distance conveyed in the Y direction (distance displaced in the Y direction). Therefore, the control unit 50 functions as a conveyance detection apparatus that detects conveyance information. The control unit 50 also controls the recording head 42 to discharge the ink according to the detected conveyance information. Therefore, the recording unit 40 can record an image without a break and without an overlap.

Specifically, to detect the conveyance information of the recording paper P, the control unit 50 first extracts a template image from first image data that is image information imaged by the imaging unit 30 at the beginning. The control unit 50 then performs pattern matching to search a pattern image similar to the template image from second image data that is image information imaged next. However, when, for example, there is slipping between the roller unit of the conveying unit 20 and the recording paper P, and the recording paper P is inclined and conveyed, the template image may not be included in the second image data. In this case, the conveyance information of the recording paper P cannot be detected, or the conveyance information can be just detected at a low accuracy even if the conveyance information can be detected. Although the imaging range of the imaging unit 30 can be expanded such that the template image falls within the second image data even if the recording paper P is inclined and conveyed, this is not preferable because the pattern matching takes a long time, or because the size of the apparatus increases.

Therefore, the control unit 50 detects the conveyance information of the recording paper P based on image information of a plurality of (for example, three or more odd number of) different regions in the image information of the imaged recording paper P in the present embodiment. More specifically, the control unit 50 extracts template images of a plurality of different regions from the first image data. The control unit 50 then performs pattern matching to search a pattern image similar to each template image from the second image data and calculates movement information of each template image. In this case, when the recording paper P is inclined and conveyed, the template image may not be included in the second image data. The movement information is not calculated, or totally different movement information is calculated. Therefore, the control unit 50 can adopt major pieces of movement information in the calculated movement information and exclude minor pieces of movement information to detect the conveyance information of the recording paper P even when the recording paper P is inclined.

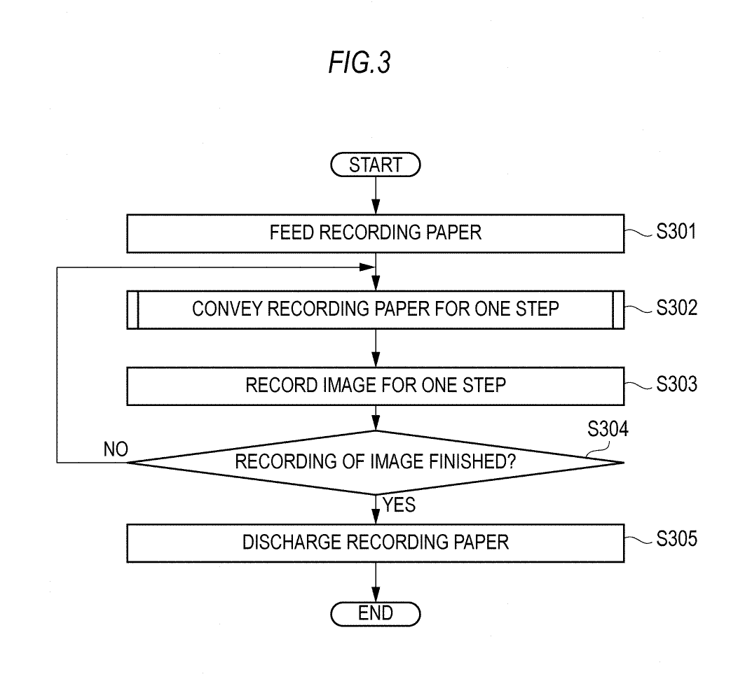

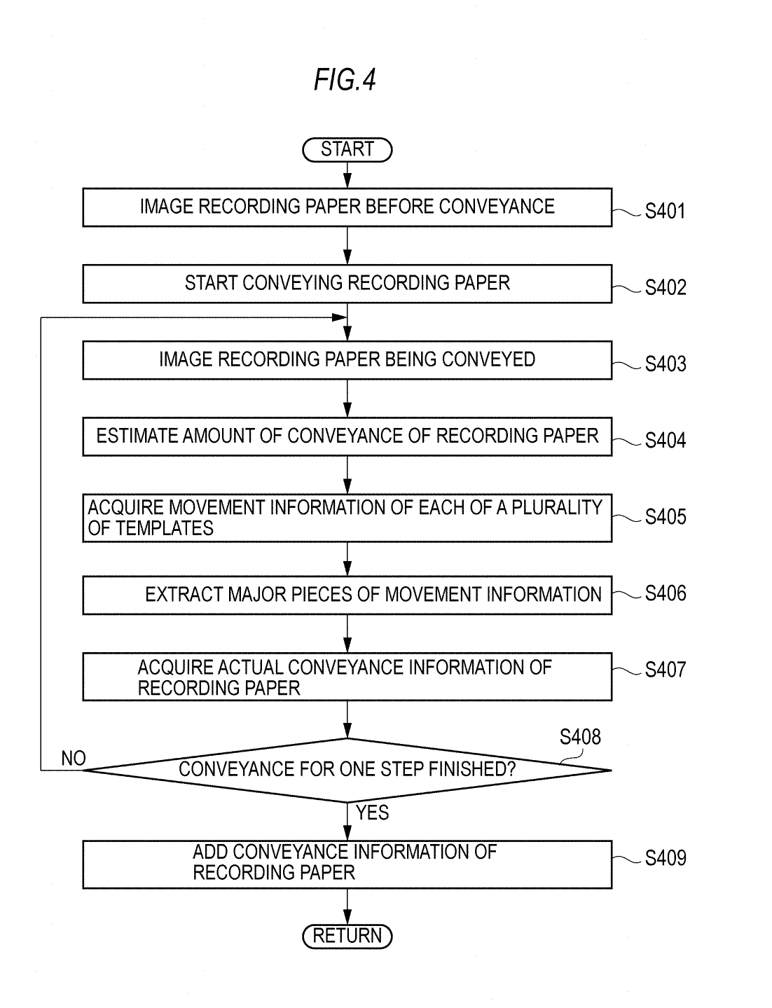

Hereinafter, a specific process by the control unit 50 will be described with reference to flow charts of FIGS. 3 and 4. The CPU 51 of the control unit 50 expands a program stored in the ROM 52 to the RAM 53 and executes the program to realize the flow charts of FIGS. 3 and 4.

In S301, the control unit 50 drives the paper feeding motor 25 to rotate the paper feeding roller unit 24 and separates each of the plurality of pieces of recording paper P loaded on the tray to feed the recording paper P from the paper feeding opening 14. The control unit 50 further sets a desired position for the recording paper P and drives the conveyor motor 23 to convey the recording paper P to a recording start position.

In S302, the control unit 50 drives the conveyor motor 23 to convey the recording paper P for one step. Based on the image information taken by the imaging unit 30, the control unit 50 also detects the conveyance information of the recording paper P actually conveyed at the conveyance of the recording paper P for one step, for example, the distance conveyed in the X direction and the distance conveyed in the Y direction. Details of the process will be described later with reference to the flow chart of FIG. 4.

In S303, the control unit 50 drives the carriage moving motor 44 to move the carriage 41 and discharges the ink from the nozzle of the recording head 42 to record the image for one step in which the recording paper P is conveyed.

In this case, the control unit 50 controls the recording head 42 to discharge the ink according to the detected conveyance information. Specifically, based on the distance conveyed in the X direction, the control unit 50 records the image throughout a region equivalent to the distance conveyed in the X direction. For example, when the distance actually conveyed is longer than the original amount of conveyance in the X direction, the image is recorded for a region including the extra length in the X direction. The control unit 50 also makes an offset equivalent to the distance conveyed in the Y direction (distance displaced in the Y direction) and records the image. The control unit 50 records the image by shifting the timing of the start of the discharge of the ink according to the distance conveyed in the Y direction when the control unit 50 moves the recording head 42 in the Y direction.

In S304, the control unit 50 determines whether all of the recording of the image is finished. If all of the recording of the image is finished, the control unit 50 proceeds to step S305. If all of the recording of the image is not finished, the control unit 50 returns to S302 to repeat the process of S302 and S303.

In S305, the control unit 50 drives the conveyor motor 23 to discharge the recording paper P with the recorded image from the paper discharge opening 15.

Next, the process of S302 will be described with reference to the flow chart of FIG. 4.

In S401, the control unit 50 instructs the imaging unit 30 to take an image before the recording paper P is conveyed from the recording start position. The imaging unit 30 images the recording paper P in an imaging range set in advance and transmits the taken image information, that is, image data, to the control unit 50. The control unit 50 applies image processing, such as shading correction, to the received image data and stores the image data after the image processing. In this case, the control unit 50 stores the image data after adding identification information to the image data. Here, the stored image data will be called first image data for the convenience.

FIG. 5 is a view illustrating an example of first image data 500 imaged by the imaging unit 30. Each rectangle in the first image data 500 illustrated in FIG. 5 indicates one pixel of the image pickup element of the imaging unit 30. To facilitate the understanding, it is assumed here that the imaging range is a range of 7 pixels×7 pixels, and the image is a gray scale image with 256 black and white gradations. In FIG. 5, a main conveyance direction, in other words, an expected conveyance direction, of the recording paper P is indicated by an arrow F.

As illustrated in FIG. 5, in the first image data 500, the brightness value varies with respect to the average brightness of the entire recording paper P due to slight unevenness on the surface of the recording paper P, and the unevenness emerges as a pattern. The control unit 50 extracts an image of a predetermined region as a template image.

In the present embodiment, the control unit 50 extracts template images of a plurality of different regions from the first image data 500. Specifically, the control unit 50 sets three or more odd number of different regions and extracts images positioned in the set regions as template images. In FIG. 5, the control unit 50 extracts three template images (regions of alternate short and long dash lines), that is, a first template image 501a, a second template image 501b, and a third template image 501c. Here, the first to third template images 501a to 501c are set to include the same number of pixels (three pixels) and are regions long in the conveyance direction F. The first to third template images 501a to 501c are set at the same or substantially the same positions in the conveyance direction and are set to offset in a direction orthogonal to the conveyance direction. In addition, the first to third template images 501a to 501c are set without gaps between pixels and not to overlap with each other in the direction orthogonal to the conveyance direction.

The control unit 50 stores brightness information and position information of each of the extracted template images. For example, the control unit 50 stores brightness values of the pixels of the first to third template images 501a to 501c and center coordinates of the first to third template images 501a to 501c in the first image data 500. In FIG. 5, the center coordinates of the first template image 501a are (X, Y)=(3, 5), the center coordinates of the second template image 501b are (X, Y)=(3, 4), and the center coordinates of the third template image 501c are (X, Y)=(3, 3).

In S402, the control unit 50 instructs the conveyor motor 23 to start conveying the recording paper P by an amount of conveyance for one target step (hereinafter, called a target amount of conveyance). Therefore, the conveyor motor 23 rotates the first conveyor roller unit 21 to convey the recording paper P for the target amount of conveyance.

In S403, the control unit 50 instructs the imaging unit 30 to image the recording paper P being conveyed. The imaging unit 30 images the recording paper P being conveyed in the same imaging range as in S401 and transmits the taken image data to the control unit 50. The control unit 50 applies image processing, such as shading correction, to the received image data and stores the image data after the image processing. In this case, the control unit 50 stores the image data after adding identification information to the image data. For the convenience, the stored image data will be called second image data here.

Here, examples of the second image data when the recording paper P is conveyed without inclination and the second image data when the recording paper P is inclined and conveyed will be described.

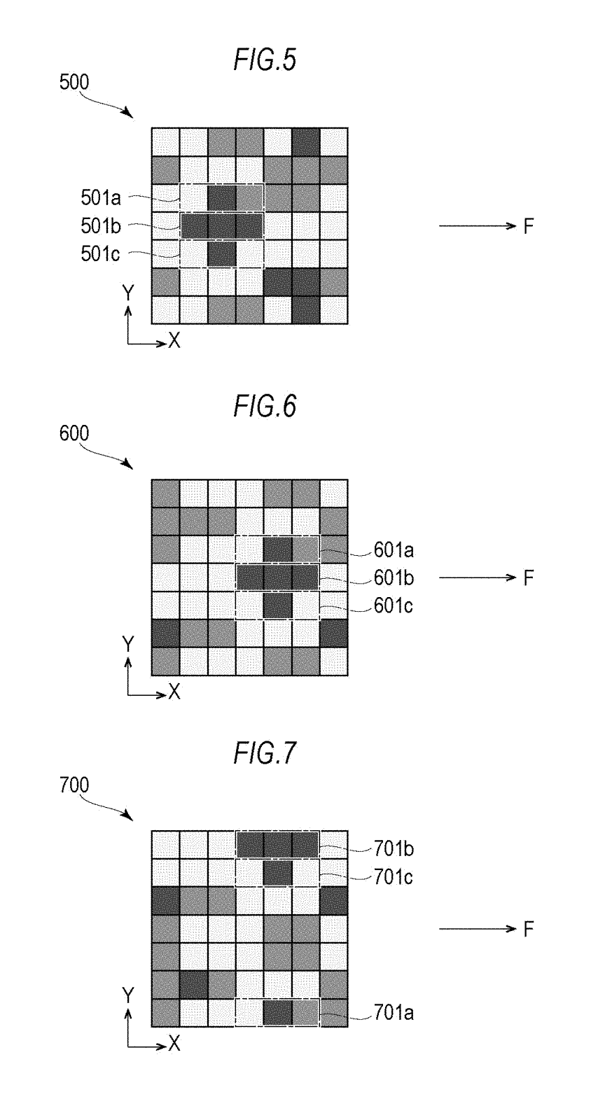

FIG. 6 is a view illustrating an example of second image data 600 imaged by the imaging unit 30 when the recording paper P is conveyed without inclination. In the second image data 600, the regions corresponding to the first to third template images 501a to 501c of the first image data 500 are moved in the conveyance direction F.

FIG. 7 is a view illustrating an example of second image data 700 imaged by the imaging unit 30 when the recording paper P is inclined and conveyed. The recording paper P is inclined and conveyed, and the components of the regions corresponding to the second template image 501b and the third template image 501c of the first image data 500 are also moved in the direction orthogonal to the conveyance direction F in addition to the conveyance direction F. Meanwhile, the region corresponding to the first template image 501a of the first image data 500 is out of the imaging range.

The timing of imaging in S403 is set in a time period (predetermined time period) in which the second image data 600 includes the regions corresponding to the first to third template images 501a to 501c of the first image data 500 when the recording paper P is conveyed without inclination. The predetermined time is stored in advance in the control unit 50 based on the imaging range and the conveyance speed.

In S404, the control unit 50 estimates an amount of conveyance of the recording paper P between the imaging of the last time and the imaging of this time. Specifically, the control unit 50 calculates the amount of conveyance of the recording paper P (hereinafter, called an estimated amount of conveyance) from the information detected by the encoder 26. The estimated amount of conveyance is detected based on the amount of rotation of the first conveyor roller unit 21 and is different from the actual amount of conveyance of the recording paper P when there is slipping between the first conveyor roller unit 21 and the recording paper P or when the first conveyor roller unit 21 is decentered. The control unit 50 stores the calculated estimated amount of conveyance.

Next, the control unit 50 detects the conveyance information of the recording paper P based on the image information of a plurality of different regions in a process from S405 to S407. The process corresponds to an example of the process by the conveyance detection unit.

In S405, the control unit 50 first acquires the movement information of each of the plurality of different regions from the first image data 500 and the second image data 600 and 700. The process corresponds to an example of the process by the movement information acquisition unit.

Specifically, the control unit 50 acquires the movement information of each template image by searching the positions of similar pattern images in the second image data 600 and 700, for each of the first to third template images 501a to 501c extracted from the first image data 500.

Here, a pattern matching method can be used as a method of searching the position of the pattern image similar to the template image. The control unit 50 uses, for example, SAD (Sum of Absolute Difference) to search the pattern images similar to the first to third template images 501a to 501c from the second image data 600 and 700 based on the brightness information of each image. In this case, based on the estimated amount of conveyance calculated in S404, the control unit 50 can search only the proximity of the estimated amount of conveyance to quickly perform the pattern matching. The control unit 50 specifies pattern images most similar to the first to third template images 501a to 501c in the second image data 600 and acquires the position information of the specified pattern images.

In the case of FIG. 6 in which the recording paper P is conveyed without inclination, first to third pattern images 601a to 601c are specified as pattern images similar to the first to third template images 501a to 501c, respectively. Here, the center coordinates of the first pattern image 601a are (X, Y)=(5, 5), the center coordinates of the second pattern image 601b are (5, 4), and the center coordinates of the third pattern image 601 are (5, 3).

In the case of FIG. 7 in which the recording paper P is inclined and conveyed, a second pattern image 701b and a third pattern image 701c are specified as pattern images similar to the second template image 501b and the third template image 501c. On the other hand, the region corresponding to the first template image 501a is out of the imaging range, and a similar pattern image cannot be specified, or a pattern image at a totally different position may be specified. The control unit 50 executes the process by determining that a similar pattern image cannot be specified when, for example, a value of SAD equal to or smaller than a predetermined value cannot be obtained.

In FIG. 7, a first pattern image 701a is specified as a pattern image similar to the first template image 501a, at a position away from the second pattern image 701b and the third pattern image 701c. Here, the center coordinates of the first pattern image 701a are (X, Y)=(5, 1), the center coordinates of the second pattern image 701b are (5, 7), and the center coordinates of the third pattern image 701c are (5, 6).

Next, the control unit 50 calculates the movement information of each template image by obtaining a difference in the X direction and a difference in the Y direction from the coordinates of the first to third template images 501a to 501c of the first image data 500 and from the coordinates of the specified first to third pattern images 601a to 601c or the coordinates of the specified first to third pattern images 701a to 701c.

In the case of FIG. 6 in which the recording paper P is conveyed without inclination, the control unit 50 can acquire the same movement information for the first to third template images 501a to 501c, the movement information indicating +2 pixels in the X direction and 0 pixels in the Y direction or movement amount of 2 pixels and movement direction of 0 degrees. Note that the movement direction of 0 degrees denotes the same direction as the conveyance direction F.

On the other hand, in the case of FIG. 7 in which the recording paper P is inclined and conveyed, the control unit 50 acquires movement information indicating that the first template image 501a has moved +2 pixels in the X direction and −4 pixels in the Y direction, or movement amount of 4.47 pixels and movement direction of −63.4 degrees. Note that the movement direction of −63.4 degrees denotes a downward movement in a direction of 63.4 degrees in FIG. 7 with respect to the conveyance direction F. The control unit 50 can acquire movement information indicating that the second template image 501b and the third template image 501c have moved +2 pixels in the X direction and +3 pixels in the Y direction, or movement amount of 3.61 pixels and movement direction of +56.3 degrees. Note that the movement direction of +56.3 degrees denotes an upward movement in a direction of 56.3 degrees in FIG. 7 with respect to the conveyance direction F.

The control unit 50 stores the acquired movement information of each of the first to third template images 501a to 501c.

In S406, the control unit 50 extracts movement information by majority rule from the plurality of pieces of acquired movement information, that is, the control unit 50 excludes minor pieces of movement information and extracts major pieces of movement information. The process corresponds to an example of the process by the extraction unit. Specifically, the control unit 50 extracts matching or substantially matching major pieces of movement information from the plurality of pieces of acquired movement information. In the present embodiment, three or more odd number of different regions serve as the template images. Therefore, even if the substantially matching movement information is divided into two groups (first group and second group), the number of pieces of movement information belonging to the first group and the number of pieces of movement information belonging to the second group do not become the same, and the major pieces of movement information is easily determined.

In the case of FIG. 6 in which the recording paper P is conveyed without inclination, the first to third template images 501a to 501c all include substantially matching movement information, and the control unit 50 extracts movement information indicating that the images have moved +2 pixels in the X direction and 0 pixels in the Y direction or movement amount of 2 pixels and movement direction of 0 degrees.

On the other hand, in the case of FIG. 7 in which the recording paper P is inclined and conveyed, the movement information of only the first template image 501a is different, and the second template image 501b and the third template image 501c include substantially matching movement information. Therefore, the control unit 50 extracts substantially matching movement information indicating that the images have moved +2 pixels in the X direction and +3 pixels in the Y direction or movement amount of 3.61 pixels and movement direction of +56.3 degrees.

Note that the control unit 50 can determine whether the movement information substantially matches based on predetermined thresholds. For example, the control unit 50 determines that compared two pieces of movement information substantially match if the movement amount of the two pieces of movement information is equal to or smaller than a predetermined number of pixels (first threshold) and the movement direction is equal to or smaller than a predetermined angle (second threshold). The predetermined number of pixels can be set to, for example, ±2 pixels, and the predetermined angle can be set to, for example, ±10 degrees.

If similar pattern images cannot be specified from the plurality of template images, and there are template images from which the movement information is not acquired in step S406, major pieces of movement information are extracted from already acquired movement information. If similar pattern images are not specified in all template images in step S406, the control units 50 determines that the recording paper P is inclined more than expected and notifies an error through a display unit or the like of the recording apparatus 100. In this case, the control unit 50 can cause the conveying unit 20 to stop the conveyance or can substitute an estimated amount of conveyance for the conveyance information to continue the process.

In S407, the control unit 50 calculates the conveyance information of the recording paper P based on the extracted movement information. The process corresponds to an example of the process by the conveyance information calculation unit. Specifically, the control unit 50 calculates average values of the plurality of pieces of extracted movement information as the conveyance information of the recording paper P.

In the case of FIG. 6 in which the recording paper P is conveyed without inclination, all of the extracted movement information includes the same movement information. Therefore, the control unit 50 calculates +2 pixels in the X direction and 0 pixels in the Y direction, or movement amount of two pixels and movement direction of 0 degrees, as the average values.

In the case of FIG. 7 in which the recording paper P is inclined and conveyed, different movement information is not extracted, and all of the extracted movement information includes the same movement information. Therefore, the control unit 50 calculates +2 pixels in the X direction and +3 pixels in the Y direction, or movement amount of 3.61 pixels and movement direction of +56.3 degrees, as the average values.

Therefore, in the imaging timing from the first image data 500 to the second image data 600 and the second image data 700, the recording paper P is conveyed according to the calculated conveyance information. The control unit 50 stores the calculated conveyance information of the recording paper P.

In S408, the control unit 50 determines whether the conveyance equivalent to one step is finished. If the conveyance equivalent to one step is not finished, the control unit 50 returns to S403 and repeats the process from S403 to S407. In this case, the control unit 50 sets the second image data to new image data acquired by returning to S403 and sets the first image data to the image data acquired in S403 of the previous time to execute the process of S405 to S407 described above. Therefore, in S403 described above, it is preferable that the control unit 50 extract predetermined regions as the first to third template images 501a to 501c as in S401 and store the brightness information and the position information, in addition to the storage of the image data after the image processing.

On the other hand, if the conveyance equivalent to one step is finished, the control unit 50 proceeds to S409. The control unit 50 proceeds to S409 when the conveyance is temporarily stopped in order for the recording unit 40 to record the image after the end of the conveyance equivalent to one step.

In S409, the control unit 50 adds all of the conveyance information stored in S407 to acquire conveyance information of the actual conveyance in the conveyance for one step. Specifically, the control unit 50 adds the pixels in the X direction and the Y direction and multiplies the added pixels by the pixel pitch to acquire the distance conveyed in the X direction and the distance conveyed in the Y direction.

In this way, the control unit 50 can acquire the conveyance information of the recording paper P actually conveyed in the conveyance for one step to thereby discharge the ink by controlling the recording head 42 according to the detected actual conveyance information in S303 described above. Therefore, the control unit 50 records the image throughout the region equivalent to the distance conveyed in the X direction based on the distance actually conveyed in the X direction and records the image after offsetting the image according to the distance displaced in the Y direction. This can prevent a broken image and an overlapped image even when the recording unit 40 records the image step by step.

According to the present embodiment, the control unit 50 detects the conveyance information of the recording paper P based on the image information of a plurality of different regions in the image information of the recording paper P imaged by the imaging unit 30. In this way, the image information of the plurality of different regions is used, and the conveyance information of the recording paper P can be detected based on the image information of other different regions even when the image information of part of the regions is out of the imaging range. Therefore, the conveyance information of the recording paper P can be accurately detected without expanding the imaging range even when the recording paper P is inclined and conveyed.

According to the present embodiment, the control unit 50 detects the conveyance information of the recording paper P based on the image information of three or more odd number of different regions. In this way, the image information of three or more odd number of different regions is used, and the numbers of pieces of movement information belonging to two divided groups do not become the same even if the movement information is divided into two groups. Therefore, the movement information to be adopted can be quickly determined, and the conveyance information can be easily detected.

According to the present embodiment, the plurality of different regions are set to offset in the direction orthogonal to the main conveyance direction of the recording paper P in the image information of the recording paper P. The plurality of different regions are offset in the direction orthogonal to the conveyance direction, and other regions can be included in the imaging range even if one region is out of the imaging range when the recording paper P is inclined and conveyed. Therefore, the conveyance information of the recording paper P can be detected based on the image information of the other different regions. However, the plurality of different regions may be set to offset in the conveyance direction instead of setting the regions to offset in the direction orthogonal to the conveyance direction.

According to the present embodiment, the plurality of different regions are set not to overlap with each other. Therefore, the movement information not affected by the other regions can be acquired by setting the plurality of different regions not to overlap with each other, compared to when the regions are set to partially overlap with each other. However, the plurality of different regions may overlap with each other, instead of not overlapping with each other.

According to the present embodiment, the plurality of different regions are set without gaps between pixels and not to overlap with each other in the direction orthogonal to the conveyance direction. Therefore, the plurality of different regions can be set in the direction orthogonal to the conveyance direction without expanding the imaging range. However, the plurality of different regions may be set at intervals instead of setting the regions without gaps between pixels.

According to the present embodiment, the control unit 50 acquires the movement information of movement of each of the different regions from the image information imaged at different timings, extracts a plurality of pieces of matching or substantially matching movement information in the acquired movement information, and calculates the conveyance information of the recording paper P based on the plurality of pieces of extracted movement information. In other words, the movement information different from the ordinary movement information is excluded to calculate the conveyance information of the recording paper P, and the conveyance information of the recording paper P can be accurately detected.

According to the present embodiment, the control unit 50 calculates the average values of the plurality of pieces of extracted movement information as the conveyance information of the recording paper P. Therefore, even if the plurality of pieces of extracted conveyance information are slightly different, the average values can be set as the conveyance information to calculate more detailed conveyance information than the conveyance information based on pixels, without execution of a process such as so-called sub-pixel position estimation.

Although the present invention has been described with reference to the embodiment, the present invention is not limited to the embodiment, and changes can be made within the scope of the present invention.

Although the first to third template images 501a to 501c are set in one row in the conveyance direction in the case described in the present embodiment, the present embodiment is not limited to this. The first to third template images 501a to 501c may be set in two or more rows in the conveyance direction.

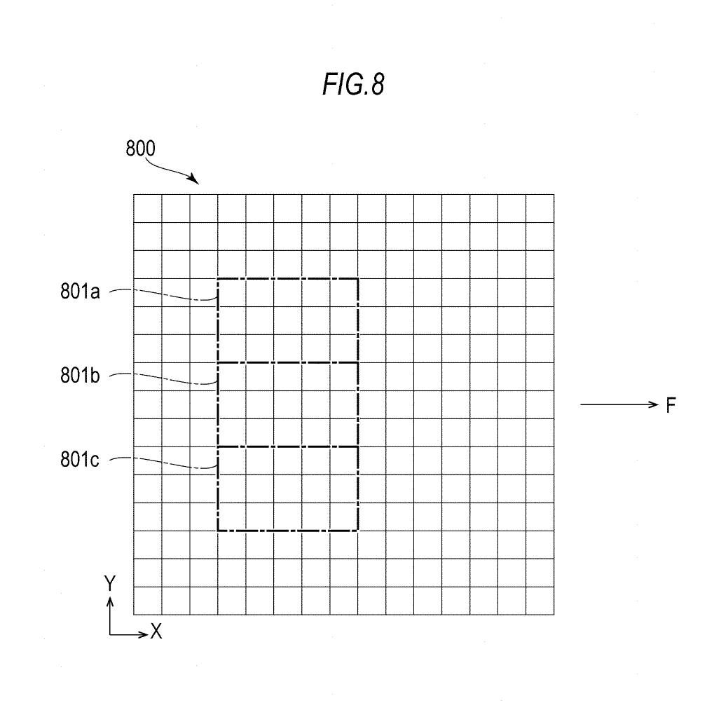

FIG. 8 is a view illustrating an example of first image data 800, and the imaging range is a range of 15 pixels×15 pixels. Here, first to third template images 801a to 801c include the same number of pixels (15 pixels) and are set in three rows in the conveyance direction F. In this way, although the imaging range is expanded, the template images may be set in two or more rows.

In the case described in the present embodiment, the process from S403 to S407 is repeated, the conveyance information of the actual conveyance for one step is acquired in S409, and the recording unit 40 records the image based on the acquired conveyance information. However, the present embodiment is not limited to this. For example, the conveyance information calculated in S407 may be fed back to control the conveyor motor 23 in real time. More specifically, the control unit 50 controls the amount of rotation of the conveyor motor 23 to reduce the amount of ration when the acquired conveyance information is long and controls the amount of rotation of the conveyor motor 23 to increase the amount of rotation when the acquired conveyance information is short. Therefore, when the conveyance for one step is finished, conveyance of the same amount of conveyance as the scheduled amount of conveyance for one step can be performed. As a result of the control, the recording unit 40 only has to always record the image for one step, and the control unit 50 can reduce the control for the recording unit 40. As a result of the control, the printer is not limited to the inkjet type in which the image is recorded step by step, and a printer of an electrophotographic type, a thermal transfer type, a dot impact type, or the like can also be used. As a result of the control, not only the recording apparatus 100, but also a conveying apparatus without the configuration of the recording unit 40 can be adopted. Note that the conveying apparatus 10 includes an image reading apparatus, such as a scanner, in which the configuration of the recording unit 40 is replaced with a configuration of an image reading unit.

Although the control unit 50 is arranged in the housing 11 in the case described in the present embodiment, the present invention is not limited to the case, and the control unit 50 may be arranged outside of the housing 11. In this case, the control unit 50 can control the conveying apparatus 10 and the recording unit 40 in a wired or wireless manner.

Although an odd number of template images are set in the case described in the present embodiment, the present embodiment is not limited to this, and an even number of template images may be set.

Although the SAD is used as the pattern matching method in the case described in the present embodiment, the method is not limited to the SAD, and SSD (Sum of Squared Difference), NCC (Normalized Cross-Correlation), or the like may be used.

Although the CPU 51 executes the program to realize the process in the case described in the present embodiment, the present invention is not limited to the case, and each circuit including hardware may execute the process.

The present invention also includes the program and a computer-readable recording medium recording the program.

According to the present invention, highly accurate conveyance information can be detected even when a conveyed object is inclined and conveyed.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

What is claimed is:

1. A conveyance detection apparatus of a conveying apparatus, the conveying apparatus comprising:
a conveying unit that conveys a conveyed object along a conveyance path; and
an imaging unit that images the conveyed object, the conveyance detection apparatus comprising
a conveyance detection unit that detects conveyance information of the conveyed object based on image information of a plurality of different regions in image information of the conveyed object imaged by the imaging unit.

2. The conveyance detection apparatus of the conveying apparatus according to claim 1, wherein
the conveyance detection unit
detects the conveyance information of the conveyed object based on image information of three or more odd number of different regions.

3. The conveyance detection apparatus of the conveying apparatus according to claim 1, wherein
the plurality of different regions are set to offset in a direction orthogonal to a main conveyance direction of the conveyed object in the image information of the conveyed object.

4. The conveyance detection apparatus of the conveying apparatus according to claim 3, wherein
the plurality of different regions are set not to overlap with each other.

5. The conveyance detection apparatus of the conveying apparatus according to claim 1, wherein
the conveyance detection unit
acquires movement information of movement of each of the different regions from the image information imaged at different timings, extracts a plurality of pieces of matching or substantially matching movement information from the acquired movement information, and calculates the conveyance information of the conveyed object based on the plurality of pieces of extracted conveyance information.

6. The conveyance detection apparatus of the conveying apparatus according to claim 5, wherein
the conveyance detection unit calculates an average value of the plurality of pieces of extracted movement information as the conveyance information of the conveyed object.

7. The conveyance detection apparatus of the conveying apparatus according to claim 1, wherein
the conveyance detection unit comprises:
a movement information acquisition unit that acquires movement information of each of the different regions from the image information imaged at different timings;
an extraction unit that extracts a plurality of pieces of matching or substantially matching movement information from the movement information acquired by the movement information acquisition unit; and
a conveyance information calculation unit that calculates conveyance information of the conveyed object based on the plurality of pieces of movement information extracted by the extraction unit.

8. A conveying apparatus comprising:
a conveying unit that conveys a conveyed object along a conveyance path;
an imaging unit that images the conveyed object; and
a conveyance detection unit that detects conveyance information of the conveyed object based on image information of a plurality of different regions in image information of the conveyed object imaged by the imaging unit.

9. A recording apparatus comprising:
a conveying unit that conveys a conveyed object along a conveyance path;
an imaging unit that images the conveyed object;
a conveyance detection unit that detects conveyance information of the conveyed object based on image information of a plurality of different regions in image information of the conveyed object imaged by the imaging unit; and
a recording unit that records an image based on the conveyance information detected by the conveyance detection unit.
